(19) United States
(12) Patent Application Publication
(10) Pub. No.: US 2007/0056038 A1
(43) Pub. Date: Mar. 8, 2007

(54) FUSION INSTRUSION PROTECTION SYSTEM

(75) Inventor: Simon Lok, Vero Beach, FL (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: LOK TECHNOLOGY, INC., Vero Beach, FL (US)

(21) Appl. No.: 11/162,310

(22) Filed: Sep. 6, 2005

(51) Int. Cl. G06F 12/14

(52) U.S. Cl. 726/23

(57) ABSTRACT

An intrusion protection system that fuses a network instrumentation classification with a packet payload signature matching system. Each of these kinds of systems is independently capable of being effectively deployed as an anomaly detection system. By employing sensor fusion techniques to combine the instrumentation classification approach with the signature matching approach, the present invention provides an intrusion protection system that is uniquely capable of detecting both well known and newly developed threats while having an extremely low false positive rate.

### DESCRIPTION

1. Field of the Invention

The present invention relates, in general, to network data communications, and, more particularly, to software, systems and methods for providing intrusion detection and protection in a networked computer system.

2. Relevant Background

The proliferation of Internet-based business activities has given rise to a dangerous world where the frequency and sophistication of human and electronic attacks requires that network administrators deploy automated systems to defend their network. Traditionally the perimeter between the Internet (where the attacks presumably will originate) and the data-center (where the critical business functions are housed) is created by a firewall device. Typically a firewall is implemented by a dedicated device that is configured to allow certain kinds of traffic to be permitted. For example, a network administrator may configure a firewall device to permit world wide web, email and instant messaging traffic. In most cases, the firewall device will identify these traffic types by session protocol (e.g., TCP) port numbers. For many years this was a viable defense mechanism. However, today, attackers have developed delivery mechanisms that use standard services for transport that are generally permitted by most firewalling policies. For example, many worms spread by sending email messages that contain malicious code that subverts the recipient's computer. In many cases, blocking these types of traffic would cripple the functionality of the network.

Intrusion detection systems (IDS) were created to address this threat by detecting attacks via network traffic analysis. Unlike traditional firewalls that make decisions based exclusively on individual packet headers, intrusion detection systems typically build up traffic context which increases the breadth of attacks that can be analyzed. Traffic context refers to qualitative and/or quantitative indication of traffic behavior, such as can be achieved by monitoring traffic over time. For example, although HTTP requests are normally allowed, a series of HTTP requests for a password protected page that is being repeatedly requested implies that an attacker is engaging in a brute force password attack.

An intrusion detection system (IDS) attempts to protect network systems by identifying suspicious traffic. Intrusion detection systems employ various techniques to imply particular network activity from monitored traffic behavior. For example, one technique uses signature patterns to identify signatures of malicious code or other unwanted traffic. Other techniques use more advanced heuristics to identify abnormal network behavior or traffic patterns. When an attack is detected, the administrator is notified. A typical response is to notify a network administrator who will modify the firewall settings (e.g., closing one or more ports) to block the attacker from further incursion. However, to effectively prevent intrusion, a system must analyze and respond to threats in real time or near real time.

More recently, intrusion protection systems (IPS) are used that build upon the IDS concept by integrating a dynamic firewalling system. IPS developed in response to the availability of software kits allowing amateurs to create worms that rapidly attack and subvert networks, thus necessitating real-time response to changing threats. Rather than simply notifying the network administrator of a problem, the IPS will automatically modify the firewall rules based on a policy specified by the administrator ahead of time. Typically the policy will be to blackhole (e.g., define a rule that drops all packets to and from a particular network address) the source of the anomalous (and presumably attacker-generated) traffic. This completely automated approach to defending the network is critical in the modern environment where networks need to remain available 24×7 and where network administrator may not always be on duty or available to deal with the situation.

Intrusion protection systems require sensors and instrumentation to make a decision as to whether or not traffic is anomalous. Most intrusion protection systems rely on a database of well known malware signatures. This is a carry-over from the virus protection world. The assumption is that all malicious activity can be identified by signatures extracted by careful analysis of network traffic. The limitation with this approach is that if you do not have a signature for a particular circumstance, it will never be detected. Before the proliferation of high-speed interconnected networks, reliance on a database containing signatures of previously identified threats was a reasonable approach because the odds were in the network administrators favor that somebody else would have come across the problem first. However, with zero day exploits on the rise, this is clearly is no longer the case.

An alternative to having a database of preexisting signatures is to analyze the behavior of the network traffic. For example, when a particular machine starts sending traffic to a very large number of machines on the Internet, then that machine is likely to have an active virus, worm, peer-to-peer file sharing software, or other undesirable processes indicating a likelihood of a problem on that machine. Although it is possible to identify that there is a likely problem, the false positive rate is high because threatening behavior alone does not indicate what specifically is happening. Furthermore, systems that take this approach tend to use only a single sensor (e.g., connection rate instrumentation).

### SUMMARY OF THE INVENTION

Briefly stated, the present invention relates to an intrusion protection system that fuses a multidimensional network instrumentation classification with a packet payload signature matching system. Each of these kinds of systems is independently capable of being effectively deployed as an anomaly detection system. By employing sensor fusion techniques to combine the instrumentation classification approach with the signature matching approach, we have created a detector that is uniquely capable of detecting both well known and newly developed threats while having an extremely low false positive rate.

In a specific implementation the present invention involves a network intrusion protection system (IPS) having a first behavioral analysis component configured to identify acceptable network packets and direct subsequent analysis stages of the IPS to bypass the acceptable network packets. The subsequent stages include a pattern matching component configured to analyze packets that were not identified as acceptable by the first behavior analysis component and classify whether the packet contents match predefined signatures corresponding to malicious patterns. A second behavioral analysis component is configured to examine packets that are not successfully classified by the pattern matching component.

### BRIEF DESCRIPTION OF THE DRAWINGS

FIG. 1 shows a port mirroring network architecture in accordance with the present invention;

FIG. 2 shows a trunk Interception Network Architecture in accordance with the present invention;

FIG. 3 shows Multi-instrument Behavioral Analysis System in accordance with the present invention; and

FIG. 4 depicts the decision tree used to fuse the behavioral analysis and signature matching anomaly detection systems.

### DETAILED DESCRIPTION OF THE PREFERRED EMBODIMENTS

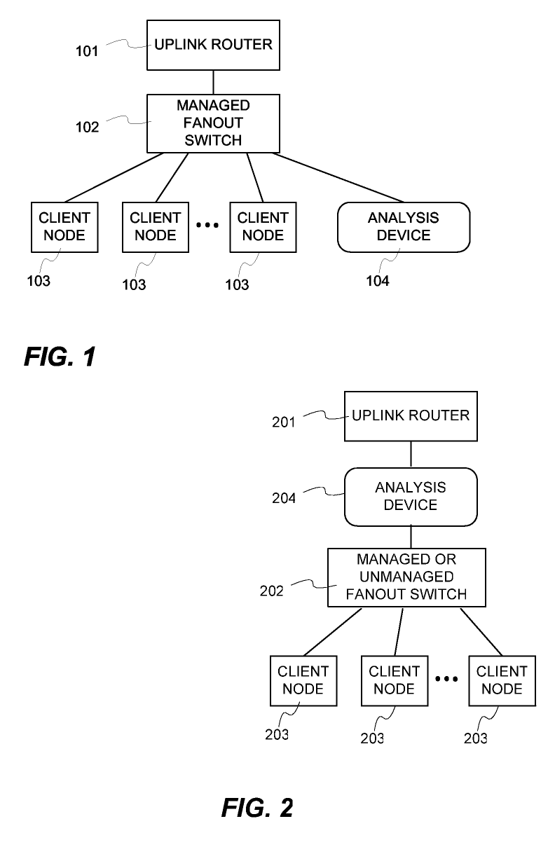

FIG. 1 depicts a network architecture where a network analysis device 104 processes all data that passes through a managed switch 102 that has been setup with a traffic mirror port. All traffic from the uplink router 101 and local network nodes 103 must travel through the backplane of the managed switch (02. Since mirror ports forward a copy of all backplane traffic, the analysis device 104 sees a copy of all traffic on the network.

Network packets that are to be considered for anomaly detection are forwarded to the analysis device 104 where network instrumentation, signature matching and sensor fusion take place. Sensor fusion refers to processes that combine the results of reading multiple independent sensors or network instruments to obtain superior results. This combination may involve simple or complex logic to meet the needs of a particular application. Sensor inputs may be differentially weighted to increase sensitivity to particular traffic behaviors. Forwarding of the appropriate set of packets to the analysis device can be accomplished in a number of ways, including but not limited to deploying a trunk interception device and enabling switch port mirroring. Fig.Switch port mirroring, shown in FIG. 1, requires a network switch 102 capable of forwarding all traffic present on the backplane out a single port. The analysis device 104 is connected to the designated mirror port.

FIG. 2 depicts a trunk interception network architecture in which a network analysis device 204 is placed inline at a critical trunk between the uplink router (201) and a fanout switch 202. In the implementation of FIG. 2, network packets communicated between the local network nodes 203 and the uplink router 201 are passed through the analysis device 204. The implementation of FIG. 2 allows the analysis device (204) to block traffic at will.

Network instrumentation is derived by analyzing the packet stream. Network instrumentation relates to processes that measure features of the network packets or frames both individually and in groups or sequences. Instrumentation that are used for anomalous behavior detection include but are not limited to the number of connections originating from or terminating to a particular node, the number of new connections per second that are originating from a node, the ratio of destination addresses to destination subnets, the variability in source and destination ports, the network protocol being employed, the packet size and the connection duration. Instrumentation can be centralized in analysis device 104 or distributed throughout the network and may include instrumentation implemented in uplink router 101, switch 102, and/or client nodes 103.

Individually, each of these instruments can be used as a behavioral traffic classifier that can detect a difference between “normal” traffic behavior and anomalous traffic behavior. For example, in most cases, if a node has more than 1,000 simultaneous open connections, there is probably something wrong. However, if that node was a very powerful server with a large client load, 1,000 simultaneous connections would be appropriate.

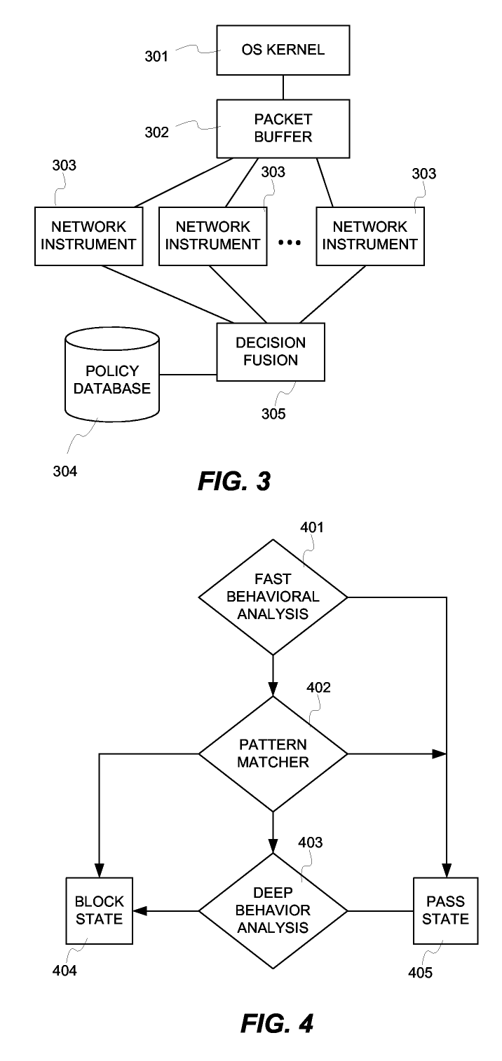

In addition, the present invention is able to reduce the amount of false positives by using the response from multiple instruments rather than a single instrument. Although the unsupervised system of FIG. 2 is reasonable, it lacks the ability to report to the administrator the exact nature of the anomaly and still is susceptible to some false positives. FIG. 3 shows a Multi-instrument Behavioral Analysis System in an embodiment of the present invention. The operating system kernel 301 places a copy of all traffic passing through an inbound interface into memory buffer 302. Multiple network instruments 303 are used to analyze and characterize the network traffic in the memory buffer 302. The individual results are passed to a decision system including classifier 305 that draws on stored policies within policy database 304 established by the administrator to classify the traffic as being normal or anomalous.

Conventional pattern matching anomaly detection systems operate the principle of comparing the payload of each and every network packet to a database of known malicious patterns. This methodology is inherently problematic in a number of ways. First, if the pattern is not in the database, then it will not be detected. This means that the database must be vigilantly maintained to keep it up to date. Although there are automated updating systems for pattern matchers, these systems are typically time driven (e.g., run once every week) as opposed to event driven (e.g., run when a new virus is discovered). Furthermore, the availability of worm authoring and operating system exploitation toolkits allows new fast-spreading threats to be created and released very quickly. Another problem with pattern matching systems is that they are typically very processor intensive and introduce significant latency into the system. Performing pattern matching against each and every packet against a large database is not an easy task.

By combining all of the instrumentation together into a single classifier 305 as shown in FIG. 3, the present invention is able to detect forms of anomalous behavior that have been previously encountered. Although a variety of classifier technologies may be used to implement classifier 305, a particular example uses a “hyperspace classifier”. A hyperspace classifier is a classifier in which arbitrary hyperspace surfaces are used to classify the inputs. By comparison, prior serial-processing architectures have not been able to share or combine the knowledge gained by one packet analysis process (e.g., one network instrument) with any of the other packet analysis processes.

FIG. 4 depicts an exemplary decision tree used to fuse the behavioral analysis (i.e., analysis of multiple instruments) and signature matching anomaly detection systems. In accordance with the present invention, behavioral analysis of the network instrumentation, desirably from a plurality of network instruments such as instruments 303 shown in FIG. 3, is used to detect possible anomalous activity. Network traffic is first passed into a behavioral analysis engine 401 tuned for low latency and high sensitivity. All normal traffic will result in the ‘pass’ state 405 where no action is taken.

Potentially anomalous traffic is passed to the signature matching engine 402. The signature matcher 402 compares the traffic passed to it with databases of known malicious and benign signatures. By passing only a portion of network traffic, the computational resources needed to analyze each and every packet that passes through the network are reduced or eliminated. The present invention enables an administrator to search against a database of known benign activity as well as known malicious activity. If the traffic matches a known benign activity, the traffic is passed along and no action is taken. When the traffic matches a well known malicious pattern, then the system will perform some responsive action such as taking a policy driven action to address the situation (e.g., blackhole the node and notify the network administrator).

If a match with a known malicious signature is made, the result is the ‘block’ state 404. Alternatively, if a match is made with a known benign signature, the ‘pass’ state 405 is the result. If no match is made, the traffic is passed to a behavioral analysis engine 403 tuned for high precision that makes the final decision to end in the pass 404 or block 405 state. Because behavioral analysis engine 403 sees only a small fraction of the total network traffic in normal circumstances, it can implement detailed, rigorous and computationally expensive analysis on the packets it receives to minimize or eliminate errors such as false positives and missed threats.

When the traffic does not match any patterns, the detection system checks the instrumentation to determine whether the traffic crosses an administrator-determined threshold for taking responsive action. When the administrator-determined threshold is exceeded the detection system performs some responsive actions which may be the same action as would have been taken when the traffic were detected to be malicious by the pattern matcher 402, except that the administrative notifications state that the anomalous behavior was not found in the database.

By fusing the input from both the behavioral analysis of network instrumentation along with a pattern matching system, the present invention is uniquely capable of detecting and reacting to known and unknown threats. Furthermore, the decision fusion system is capable of much higher performance than traditional pattern matchers alone because only potentially anomalous traffic is analyzed using computationally expensive procedures for problems. In addition, decision fusion allows the present invention to improve upon the concept of behavioral analysis alone by allowing the administrator to know exactly what the nature of the problem is (i.e., worm, virus, dictionary attack, port scan, etc.) as opposed to simply being notified of the existence of a problem. The present invention also improves on the behavioral concept by adding the database of benign activity to reduce false positives. All of this technology makes the present invention attain extraordinarily high recall while maintaining a low false positive rate.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A network intrusion protection system comprising:
a multidimensional network instrumentation classification component configured to receive instrumentation information from a plurality of network instruments; and
a packet payload signature matching component coupled to the multidimensional network instrumentation classification component.

2. The system of claim 1 wherein the classification component further comprises:
an interface for communicating with a plurality of external instrumentation processes that operate to measure network traffic characteristics.

3. The system of claim 1 wherein the instrumentation processes comprise processes that measure two or more network traffic characteristics selected from the group consisting of:
a number of connections originating from and/or terminating to a particular node;
a number of new connections per second that are originating from a node;
a ratio of destination addresses to destination subnets;
a variability in source and destination ports;
a network protocol being employed;
a packet size; and/or
a connection duration.

4. The system of claim 2 wherein the multidimensional network instrumentation classification component comprises acceptable performance ranges defined for each instrumentation process and anomalous behavior is indicated by network traffic that causes more than one instrumentation process to exceed the acceptable performance ranges.

5. The system of claim 1 wherein the payload signature matching component is configured to operate only on packets that are classified as potentially anomalous by the multidimensional network instrumentation classification component.

6. The system of claim 1 wherein the payload signature matching component comprises:
a first set of signatures that are indicative of malicious patterns; and
a second set of signatures that are indicative of benign patterns.

7. The system of claim 6 wherein the payload signature matching component determines whether network traffic matches a benign pattern and passes the traffic along to a destination node.

8. The system of claim 6 wherein the payload signature matching component determines whether network traffic matches a malicious pattern and initiates predetermined responsive action.

9. The system of claim 6 wherein when the payload signature matching component determines that network traffic does not match either a benign pattern or a malicious pattern, the multidimensional network instrumentation component is checked to determine whether predefined instrumentation thresholds have been exceeded.

10. A network intrusion protection system (IPS) comprising:
a first behavioral analysis component configured to identify acceptable network packets and direct subsequent analysis stages of the IPS to bypass the acceptable network packets;
a pattern matching component configured to analyze packets that were not identified as acceptable by the first behavior analysis component and classify whether the packet contents match predefined signatures corresponding to malicious patterns; and
a second behavioral analysis component configured to examine packets that are not classified by the pattern matching component.

11. The system of claim 10 wherein the pattern matching component further comprises mechanisms to classify whether the packet contents match predefined signatures corresponding to benign patterns and direct the second behavior analysis component to bypass packets determined to match a benign pattern.

12. The system of claim 10 wherein the second behavioral analysis component has higher precision than the first behavioral analysis component.

13. The system of claim 10 further comprising mechanisms to block only packets that have been analyzed by at least the first behavioral analysis component and the pattern matching component.

14. The system of claim 10 wherein at least one of the first behavioral analysis component and the second behavioral analysis component comprises an interface for communicating with a plurality of external instrumentation processes that operate to measure network traffic characteristics.

15. The system of claim 10 wherein at least one of the first behavioral analysis component and the second behavioral analysis component comprises acceptable performance ranges defined for each instrumentation process and anomalous behavior is indicated by network traffic that causes more than one instrumentation process to exceed the acceptable performance ranges.

16. A method for providing network intrusion protection comprising:
monitoring network traffic;
generating a plurality of instrumentation metrics for the monitored network traffic;
determining from the plurality of instrumentation metrics in combination whether the network traffic exhibits anomalous behavior;
for network traffic that exhibits anomalous behavior performing payload signature matching to determine whether the payload of network traffic matches predefined signatures.

17. The method of claim 16 wherein the act of generating a plurality of instrumentation metrics comprises measuring two or more network traffic characteristics selected from the group consisting of:
a number of connections originating from and/or terminating to a particular node;
a number of new connections per second that are originating from a node;
a ratio of destination addresses to destination subnets;
a variability in source and destination ports;
a network protocol being employed;
a packet size; and
a connection duration.

18. The method of claim 16 wherein anomalous behavior is indicated by two or more instrumentation metrics exceeding predetermined boundaries.

19. The method of claim 16 wherein the act of performing payload signature matching comprises:
determining whether the network traffic matches a first set of signatures that are indicative of malicious patterns; and
determining whether the network traffic matches a second set of signatures that are indicative of benign patterns.

20. A network intrusion detection system implementing the method of claim 16.
